(19) United States
(12) Patent Application Publication
(10) Pub. No.: US 2025/0328815 A1
(43) Pub. Date: Oct. 23, 2025

(54) CONTINUOUS UPDATE OF A MACHINE LEARNING WORKFLOW USING PROGRAMMATIC INSTANCES

(71) Applicant: Capital One Services, LLC, McLean, VA (US)

(72) Inventors: Urvish PATEL, Reston, VA (US); Payam VAEZI, McLean, VA (US); Vannia GONZALEZ MACIAS, Glen Allen, VA (US)

(73) Assignee: Capital One Services, LLC, McLean, VA (US)

(21) Appl. No.: 18/641,260

(22) Filed: Apr. 19, 2024

(51) Int. Cl. G06N 20/00; G06F 9/48

(52) U.S. Cl. CPC G06N 20/00; G06F 9/4881

(57) ABSTRACT

Methods and systems for continuous update of a machine learning workflow. In some aspects, a system may be used to maintain and update workflows utilizing machine learning. The system receives a request for deploying a workflow including (i) the workflow and (ii) criteria for modification of a timeout interval for the workflow. The system may initialize the workflow by executing a batch processing task that consumes data from a data store and builds a model state for a model and may generate a parameter configured to dynamically modify based on specific conditions of the workflow based on the given criteria. The system may deploy the workflow by generating instances, each configured with the parameter. The system may modify a value of a corresponding parameter based on the specific conditions of the workflow. When a compute instance has met/exceeded the time value, the instance may be terminated.

### BACKGROUND

Many everyday services, such as those provided online, rely heavily on machine learning and the accuracy of machine learning models in their ability to predict, for example, outcomes and anomalies. For example, in healthcare applications, such accuracy can be crucial in improving patient outcomes. In malicious activity detection, such accuracy in detecting anomalies is important in preventing harm to users. In many cases as well, accuracy is often improved with frequent updates to the model, such as for example, by refitting models with newer or more numerous samples. However, the frequency of retraining is highly dependent on the task and type of data. For example, in cases where the data is highly dynamic, the model may need to be retrained more frequently to maintain the relevance and accuracy of the model and be able to provide the end-users with any valuable output. While many services utilize machine learning, it is often difficult to maintain consistent re-fitting or re-building of model states using new history.

### SUMMARY

Accordingly, systems and methods are described herein for novel uses and/or improvements related to re-fitting or re-building model states. For example, in order to refit models to keep them up to date, traditional operators of such services are typically required to orchestrate multiple different services from different platforms for frequent model re-fitting and state building, which, especially when using batch processing, can quickly become resource-intensive. Scheduling a re-fit of the model too frequently can thus be resource wasteful, while scheduling too infrequently can cause incorrect classifications, which can be detrimental to those who rely on the model for correct classifications or automations in relation to their health, their work, and/or the like. Furthermore, for users with little technical knowledge, such platforms are difficult to use effectively, which may impact the accuracy of the models or the operator's ability to keep their service online.

In particular, workflows that use machine learning, often anomaly detection solutions, are typically complex orchestrated services having different synchronous or asynchronous pipelines. A batch service typically re-fits the model, persisting the model artifact in storage with indexed labeling, while a stream service synchronously or asynchronously consumes the new artifacts to update either the model weights or a particular model state that requires refreshed history. In traditional systems, a model developer therefore needs to orchestrate multiple services including a batch service for repeated and frequent model re-fitting and/or model state building that may persist a model artifact in a storage service.

For developers or operators with little technical knowledge, maintaining and updating workflows using traditional techniques is a difficult task. Further, in updating workflows, services are often removed from active operation or otherwise discontinued from current processes, so that end users are unable to access the services provided by the workflows during such retraining and/or refitting processes. In particular, operators are unable to maintain workflows while balancing optimization of resources and accuracies of models in the workflow using conventional techniques, especially as such traditional techniques do not enable continuous deployment and update of such workflows in a manner that is easily configurable. Thus, the inability to easily re-fit models only when needed presents a significant technical challenge to model use.

Therefore, methods and systems herein are described that use a customizable parameter to represent a time-out interval for retraining or refitting the model (e.g., through user-determined criteria). Based on a parameter that can change and adjust based on the specific workflow, systems described herein are enabled to re-fit the model automatically using newer data. By doing so, even operators without technical knowledge are enabled to easily customize the retraining and/or refitting of such models, e.g., without the need to continuously monitor and adapt the model based on the specific operational metrics of the workflow (e.g., including instances of the workflow), such as time elapsed, performance, amount of data streamed in since last trained, etc. In this way, operators are also no longer required to perform various tasks to determine resource allocation for model training. Such techniques can save on resource-intensive model retraining when unnecessary, but also prevent bad outcomes that may occur where anomalous detection is outdated. Specifically, such techniques would enable entities to continuously update and deploy machine learning models, e.g., by refitting the models using newer data. One method for doing so includes configuring instances of a workflow with a dynamic parameter that reflects when an instance has a model that is outdated and needs re-fitting.

Therefore, methods and systems are described herein for enabling continuous updating of workflows using ML, such as by deploying a predetermined number of instances of the same workflow, each instance configured with a dynamic runtime workflow parameter having a value configured to dynamically modify based on specific conditions of the workflow. When the parameter indicates that, for example, too much time has elapsed, the corresponding instance may be terminated and another deployed in its place (e.g., including retraining the machine learning model by resetting parameters of the model state and/or refreshing the machine learning model by updating parameters of the model state using historical data).

Various other aspects, features, and advantages of the system will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows an illustrative system for updating a machine learning workflow, in accordance with one or more embodiments of this disclosure.

FIG. 2A illustrates an example of a data structure for machine learning workflow data, in accordance with one or more embodiments of this disclosure.

FIG. 2B illustrates an example of a data structure for a compute instance for a machine learning workflow, in accordance with one or more embodiments of this disclosure.

FIG. 3 shows illustrative components for a system used for updating a machine learning workflow, in accordance with one or more embodiments.

FIG. 4 is a flowchart of a method for updating a machine learning workflow, in accordance with one or more embodiments.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

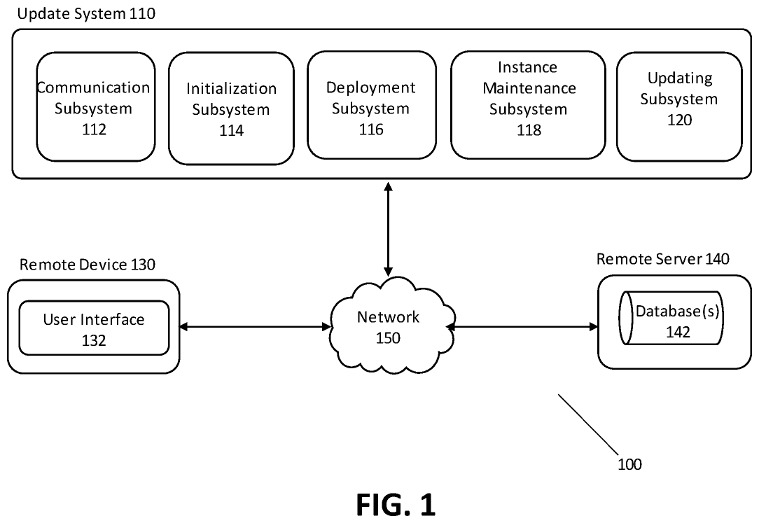

FIG. 1 shows an illustrative environment 100 for updating a machine learning workflow, in accordance with one or more embodiments of this disclosure. Illustrative environment 100 includes an update system 110 which may be used to enable entities to continuously update and deploy workflows that use machine learning models. For example, workflows that use machine learning can be updated by refitting the models using newer data. This is especially important for workflows that utilize streaming data. As referred to herein, using streaming data may refer to data of a continuous nature, being processed, in some cases, in real-time or near real-time. Workflows as discussed herein may include workflows that run inferencing tasks on data from a streaming source and may require regular retraining the model using newer data from a batch source.

In particular, the update system 110 may maintain and monitor instances of a workflow (e.g., workflows that employ machine learning) to be configured such that they may be terminated according to one or more customizations and/or based on conditions predetermined by a user to make room for a new, more updated instance.

The environment may include the remote device 130, from which the system may receive requests for deploying workflows, or to which the system may transmit notifications, e.g., to developers or operators, to alert them when events occur (e.g., when instances of the workflow are terminated, generated, an anomalous event occurs, etc.). In some examples, the environment may also include remote server 140 which may be used to store programmatic code for executing the workflow, including parameters of machine learning models executed during the course of the workflow.

The update system 110, remote server 140, and/or remote device 130 may be in communication via the network 150. Network 150 may be a wired or wireless connection such as via a local area network, a wide area network (e.g., the Internet), or a combination thereof. The update system 110 may include communication subsystem 112, initialization subsystem 114, deployment subsystem 116, instance maintenance subsystem 118, and updating subsystem 120.

As described herein, the update system 110 may be used to continually update workflows that use machine learning. For example, the update system 110 may do so by implementing and monitoring a number of instances (e.g., also referred to herein as compute instances) for a workflow. When implementing the instances, the system may configure each with a dynamic parameter that is configured to change value based on conditions (e.g., time elapsed during execution). Based on the value of the dynamic parameter, the system may determine to terminate the instance and implement a new replacement instance, which may comprise a more updated model due to retraining and/or refitting the machine learning model of the workflow by resetting or refreshing parameters of the model state.

For example, a user, such as an operator or developer, may transmit a request to deploy a workflow that uses one or more machine learning models. As referred to herein, a workflow may include a programmatic workflow, and may refer to a series of automated processes and tasks, which may be orchestrated through programming (e.g., programmatic code, configuration data, etc.). Using such workflows leverages code to automate repetitive and complex tasks, thereby increasing efficiency, reducing the likelihood of human error, and ensuring consistency and repeatability in operations. The workflow may enable systematic execution of a sequence of tasks, such as data collection, analysis, transformation, and the subsequent application of business logic or machine learning algorithms.

Programmatic workflows may rely on tools and technologies such as scripting languages, workflow automation platforms and various software development frameworks. For workflows that include execution of machine learning techniques, e.g., such as for classification, anomaly detection, and/or the like, workflows may include processing steps such as extracting data, cleaning, and preprocessing data, as well as training the models and deploying them for predictions or for generation.

A user (e.g., a developer or operator) may transmit a request for deploying a workflow such as through remote device 130 via user interface 132. The update system 110 may receive the request at the communication subsystem 112 of the system. Communication subsystem 112 of update system 110 may include software and/or hardware components allowing for the transmission and/or receipt of information between two or more devices. For example, the communication subsystem 112 may include a wireless communication subsystem, such as a cellular radio or Wi-Fi antenna, to allow for communication over wireless networks, and/or may include a network card (e.g., a wireless network card and/or a wired network card) that is associated with software to drive the card.

As described herein, the communication subsystem 112 may receive the request, e.g., from a user, for deploying a workflow. According to some examples, the communication subsystem 112 may receive a request for deploying a workflow from a user at a user device, wherein the request includes the workflow and one or more criteria for modification of a timeout interval for the workflow. For example, as described herein, criteria for modification may define conditions under which different instances of the workflow are terminated or continue to run.

The workflow may include, e.g., computer code or configuration data that, when applied or executed, perform the steps of the workflow. In some examples, the criteria for modification of the timeout interval for the workflow may include a maximum amount of time elapsed since a recorded start time of each compute instance of the workflow before termination of the at least one compute instance. In particular, a developer may determine a period of time after which the workflow should be updated, such that the model used in the workflow may be retrained or refreshed (e.g., to retain accuracy). To do so, the developer may specify a maximum amount of time that can be elapsed since the start (e.g., deployment) of any given instance, such that once the period of time has elapsed, the instance can be terminated, and replaced with a new instance (e.g., where the new instance includes an updated model).

The communication subsystem 112 may then pass the workflow and/or the criteria, or a pointer to the data in memory, to the initialization subsystem 114, where the system may initialize the workflow prior to creating and deploying different instances of the workflow. The system may initialize the workflow by executing a batch processing task that consumes data from a data store and builds a model state for a machine learning model of the workflow. According to some examples, the data store may be part of, or stored completely within the database(s) 142 of the remote server and may be accessed by the system via the communication subsystem 112 through the network 150. Alternatively, or additionally, the data store may be accessed locally.

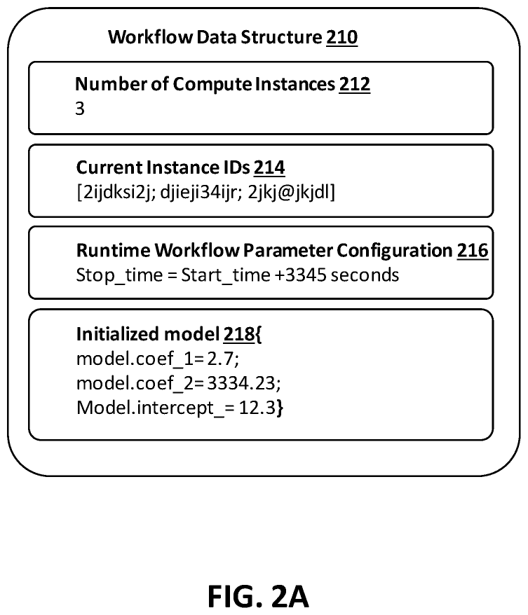

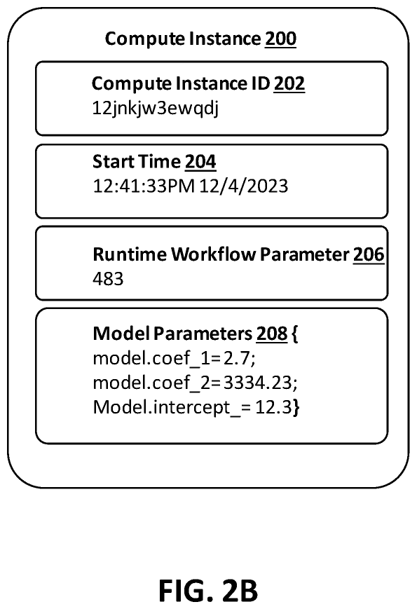

The initialization subsystem 114 may be configured to initialize the workflow by extracting a large set of data, e.g., from a data store as discussed. The batch processing task can be used to process this data, e.g., in an automated manner. In some examples, processing the data may include steps like filtering, cleaning, and transformation. Once the data is processed, the system may then use the data to build an initial model state for a machine learning model within the workflow. This step may involve training the machine learning model, defining its parameters, configuration, etc. In order to initialize the workflow for deployment via one or more compute instances, the initialization subsystem 114 may generate a data structure for keeping track of different instances of the workflows and for defining the dynamic workflow parameter based on the criteria specified. For example, FIG. 2A illustrates an example of a workflow data structure 210 for a machine learning workflow, in accordance with one or more embodiments of this disclosure.

The workflow data structure 210 may reference the number of compute instances 212 of the workflow that should be active (e.g., deployed) at any given moment and may also identify the specific compute instances, e.g., via current instance IDs 214. For example, the workflow may be preset with a desired replica count such that when one compute instance fails, the replacement compute instance is generated and deployed to maintain the desired replica count. In some examples, the number of compute instances of the workflow to be deployed may be defined in the request, e.g., by the user. As referred to herein, an instance may refer to a specific occurrence or execution of a predefined workflow process. Each instance may follow the sequence of steps and tasks defined in the workflow but may operate on different data, and/or under different circumstances. An instance is also referred to as a compute instance herein.

In the example of FIG. 2A, the number of compute instances is 3, indicating that at any point in time, 3 compute instances may be deployed. For example, if a compute instance is terminated (e.g., due to meeting one or more criteria defined in the request), a new compute instance may be created and deployed such that the number of compute instances (e.g., 3) is met. Once compute instances are generated and deployed as discussed in relation with FIG. 2B, the workflow data structure 210 may also store the identifiers of instances that are currently being deployed, e.g., in order to keep track of the number of compute instances as well as monitor their performance.

The workflow data structure 210 may include the model parameters of one or more machine learning models used in the workflow. For example, as described herein, a batch processing task can be used to process data, e.g., in an automated manner to then be used in building an initial model state for a machine learning model within the workflow. The parameters of the initial model state, or a pointer to the data in memory, may be stored in the workflow data structure 210 as initialized model 218.

As described herein, each of the workflow data structures may further include a runtime workflow parameter configuration 216, which specifies the different conditions for terminating and/or continuing to run an instance. As described herein, the system may receive, e.g., from a user at a remote device, one or more criteria for modification of a timeout interval for the workflow. For example, as described herein, criteria for modification may define conditions under which different instances of the workflow are terminated or continue to run. Once the timeout interval is exceeded, e.g., the time has lapsed, the workflow may automatically terminate. In the example of FIG. 2A, the runtime workflow parameter configuration 216 is defined as “Stop_time=Start_time+3345 seconds,” indicating that an instance of the workflow should terminate at 3345 seconds after the start time, e.g., the time when the instance is deployed.

As described herein, the deployment subsystem 116 may generate and deploy different instances of the workflow. For example, the initialization subsystem 114 may pass the built initial model state for one or more machine learning models used in the course of the workflow. The deployment subsystem may initialize and deploy the pre-determined number of instances, e.g., as determined by the user.

For example, the deployment subsystem 116 may load a workflow definition, which could be in the form of code, scripts, configuration files, models in workflow engines. The deployment subsystem 116 may initialize the workflow instance with the necessary parameters including input data, user context, environmental variables or configurations specific to the instance. In particular, each compute instance may be configured with the dynamic runtime workflow parameter based on the criteria defined in the request.

Depending on the workflow's requirements, the system may allocate the necessary resources for the instance, including virtual machines, containers, and/or allocating memory and CPU resources. According to some examples, the deployment subsystem 116 may ensure that the target environment in which to execute the instance (e.g., server, cloud, container, etc.) is ready to receive the workflow instance by setting up networks, databases and other dependencies. In some examples, the deployment subsystem 116 may automatically deploy the instances, e.g., upon determining that one or more conditions and tests are passed. In other examples, the deployment subsystem 116 may prompt the user, e.g., through a notification transmitted to a remote device via the network, to enable or allow the instance to be deployed.

Once deployed, the instance maintenance subsystem 118 may store data regarding each compute instance and workflow. The instance maintenance subsystem may be configured to monitor the execution of each workflow and be enabled to terminate each compute instance based on conditions of the workflow. For example, the instance maintenance subsystem may include data on each instance. FIG. 2B illustrates an example of a data structure for a compute instance 200 for a machine learning workflow, in accordance with one or more embodiments of this disclosure.

The compute instance 200, once deployed, may be identified via an identifier 202. As referred to herein, an identifier may be any alphanumeric string of any length. The compute instance 200 may further include a start time 204, which may indicate the time at which the compute instance is deployed. As described herein, the system may further configure each compute instance 200 with a runtime workflow parameter 206, which may be indicative of when a compute instance will terminate. In some examples, the value of the workflow parameter may be configured to dynamically modify based on specific conditions of the workflow.

The instance maintenance subsystem may modify, for at least one compute instance, a value of a corresponding dynamic runtime workflow parameter based on the specific conditions of the workflow. In one example, the dynamic runtime workflow parameter may be indicative of a time left until the instance is to be terminated, e.g., and replaced by a new instance. The instance maintenance subsystem may modify the dynamic runtime workflow parameter to reflect the time left, e.g., based on a current time and a start time of the instance.

The instance maintenance subsystem may determine, based on the dynamic runtime workflow parameter and the start time of the at least one compute instance, that the at least one compute instance has met or exceeded a time value indicated by the dynamic runtime workflow parameter. In response to a determination that the time value indicated by the dynamic runtime workflow parameter has been met or exceeded (e.g., time left is 0, the current time exceeds the stopping time, etc.), the instance maintenance subsystem 118 may terminate the instance. For example, the instance may be terminated by running a command automatically for terminating or deleting the instance. Alternatively, or additionally, once the value indicated by the dynamic runtime workflow parameter has been met or exceeded, the system may transmit a notification to an operator, e.g., at a remote device via communication subsystem and network 150, to notify the operator of termination, to prompt the operator to enable termination, or to prompt the operator to manually terminate the instance.

Responsive to detecting that the compute instance has been terminated, the system may automatically generate and deploy a replacement compute instance as described herein in reference to the deployment subsystem 116. For example, the workflow may be deployed with a replica-set deployment type ensuring that the container service is always re-started if terminated. As referred to herein, a container service may refer to a cloud-based or on-premises platform that allows users to manage and run containers. Containers may refer to lightweight, portable, and isolated environments that encapsulate an application and its dependencies, making it easier to develop, deploy, and scale applications across different computing environments.

In some examples, initializing the replacement compute instance may include retraining the machine learning model by resetting parameters of the model state. For example, the new compute instance may begin execution from the top of the workflow, which may include model retraining from batch source, prior to resuming inference on data from a streaming source using the newly retrained model. Alternatively, or additionally, initializing the replacement compute instance comprises refreshing the machine learning model by updating parameters of the model state using historical data.

For example, once the compute instance has been terminated and when a new instance is generated, the updating subsystem 120 may refresh and/or retrain the machine learning model in order to maintain the accuracy and relevance of the model. Being able to do so may be particularly important where data is rapidly evolving. For example, as discussed herein, the workflow may be configured to provide inferences or classifications using a continuous flow of data from an input (e.g., sensor input, network data, etc.) and the streaming data may be used to refresh and retrain. The updating subsystem 120 may collect new data, e.g., historically recent data, that reflects the current state of the problem domain, which is representative of the applications of the model. The new data may be preprocessed (e.g., cleaned, normalized, etc.) in order to reformat the data to be consistent with the model.

The model may be retrained or refreshed using the new data. In one example, the model may be updated by refreshing the model that was trained by the initialization subsystem 114, e.g., through patch processing. In particular, the updating subsystem 120 may add recent or additional data to the dataset that the model uses. The updating subsystem may then adjust the model parameters based on the new data or feedback without a complete retraining. In some examples, the adjusted model parameters may be stored, e.g., as part of the compute instance (e.g., model parameters 208). In particular, techniques such as transfer learning or incremental learning may be utilized.

Alternatively or additionally, the model may be retrained in the replacement compute instance. For example, the system may add or replace the dataset with new data and re-run the training process. For example, the updating subsystem 120 may preprocess the new data and concatenate the original training data, or a part thereof, to the newly preprocessed data. The model may be trained using the dataset in order to obtain new model parameters. The model parameters may be stored, e.g., as part of the compute instance.

According to some embodiments, at any point in time, a user, e.g., at remote device 130 via user interface 132, may modify values for the dynamic runtime parameter, or may generate commands to customize the workflow and/or the execution and deployment of specific instances. For example, the user may modify the parameter to terminate instances at a closer of further point in time, or may instruct the system to cease execution of an instance.

According to some examples, the workflow may, at least in part, be used in identifying an anomalous event based on an output of the machine learning model of the workflow. For example, the workflow may be able to identify anomalous events to determine potential malicious activity events. Responsive to determining an anomalous event, the system may be configured to transmit, e.g., to a remote device, a notification indicative of occurrence of the anomalous event. For example, the workflow may be used to identify anomalous events that may indicate fraudulent activity of a person's account (e.g., bank account, credit card account) and may notify a user (e.g., custodian of a bank account or card) at a remote device via a notification or alert. The user may use the remote device responsive to such an alert or notification to then perform actions associated with the anomalous event, e.g., such as to enable the event (e.g., proceed with a purchase), to report the event, to freeze an account, etc.

According to some examples, the system may be further configured, e.g., via communication subsystem 112, to receive values indicative of performance of the machine learning model. For example, the machine learning model may be used to identify anomalous events and may use user's responses to the identified event to determine whether the events are anomalous and indicative of fraud or not. The system may use such data to determine whether the model is accurate, e.g., predicting anomalous, potentially fraudulent events at a high rate. Responsive to determining that the values do not meet a minimum threshold performance, the system may cause the machine learning model to be refreshed by updating parameters of the model state using historical data and/or retraining the machine learning model by resetting parameters of the model state, e.g., as described herein with reference to FIG. 2A and FIG. 2B.

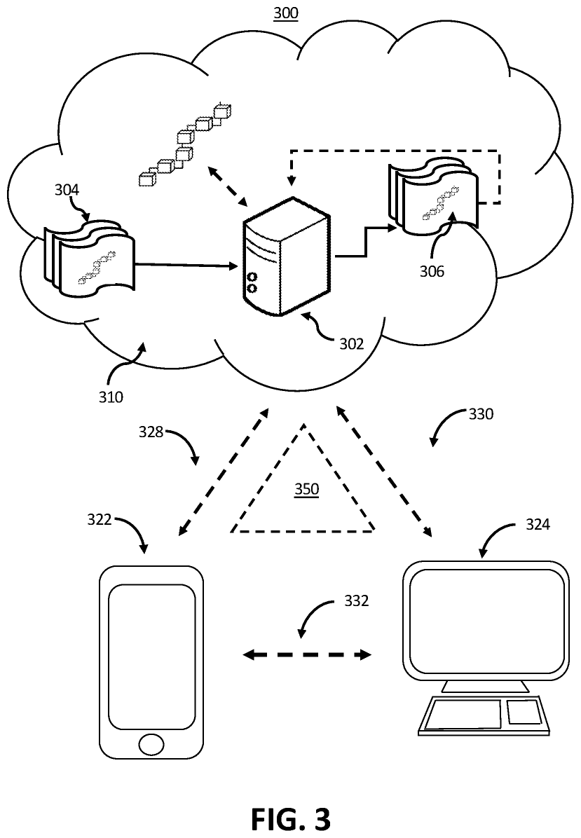

FIG. 3 shows illustrative components for a system used for updating a machine learning workflow, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310.

Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include update system 110, and components of update system 110, remote device 130, remote server 140, and/or network 150. Cloud components 310 may include model 302, which may be a machine learning model, AI model, etc. (which may be referred to collectively as “models” herein). Model 302 may take inputs 304 and provide outputs 306. The inputs may include multiple datasets, such as a training dataset and a test dataset.

Each of the plurality of datasets (e.g., inputs 304) may include data subsets related to user data, predicted forecasts and/or errors, and/or actual forecasts and/or errors. In some embodiments, outputs 306 may be fed back to model 302 as input to train the model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem-solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., sensitive, non-sensitive information). The model 302 may also output a confidence measure for the classification.

In some embodiments, the model (e.g., model 302) may automatically perform actions based on outputs 306. In some embodiments, the model (e.g., model 302) may not perform any actions. The output of the model (e.g., model 302) may be used minimize strain on computational capacity of preprocessors when analyzing multi-modal data in real-time.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of the API layer 350 may provide integration between front end and back end. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their subsystems. API layer 350 may use a developer portal. API layer 350 may use strong security constraints applying WAF and DDOS protection, and API layer 350 may use RESTful APIs as standard for external integration.

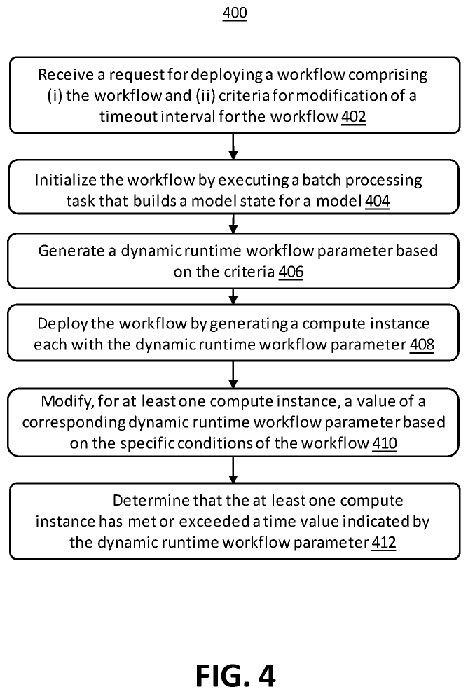

FIG. 4 is a flowchart of a method for updating a machine learning workflow, in accordance with one or more embodiments. For example, the system may use process 400 (e.g., as implemented on one or more system components described above) for retraining or refreshing a model used in a workflow automatically using newer data, without the need for technical maintenance by an operator.

At step 402, process 400 (e.g., using one or more components described above) includes receiving a request for deploying a workflow comprising (i) the workflow and (ii) criteria for modification of a timeout interval for the workflow. For example, the system may receive a request for deploying a workflow from a user at a user device. By doing so, user-defined criteria can be used to optimize the model's accuracy by refreshing or retraining the model in a customizable way. By specifying the specific conditions under which a user wants the model to be refreshed or retrained, the user can limit unnecessary processing and/or prevent training too infrequently which can subsequently lead to high rates of errors.

In some examples, the criteria for modification of the timeout interval for the workflow may include a time-limit, e.g., such as a maximum amount of time that can elapse since a recorded start time of each compute instance of the workflow before termination of the at least one compute instance. According to one embodiment, a workflow may include a programmatic workflow, and may refer to a series of automated processes and tasks, which may be orchestrated through programming (e.g., programmatic code, configuration data, etc.). This time limit serves as a boundary condition for the operation of each compute instance, ensuring that no instance runs indefinitely and consumes excessive resources.

According to some examples, the output of a machine learning model of the workflow, at least in part, may be used in identifying an anomalous event (e.g., potential malicious activity events). Responsive to determining an anomalous event, the system may be configured to transmit, e.g., to a remote device, a notification indicative of occurrence of the anomalous event. For example, a workflow may be used to identify anomalous events that may indicate fraudulent activity of a person's account and subsequently notifies a user at a remote device via a notification or alert. Responsive to such an alert or notification, the user may use the remote device to perform actions associated with the anomalous event, such as enabling the event (e.g., proceed with a purchase), reporting the event, freezing the account to prevent further malicious activities, etc.

At step 404, process 400 (e.g., using one or more components described above) includes initializing the workflow by executing a batch processing task that builds a model state for a model. As an example, the system may initialize the workflow by executing a batch processing task that consumes data from a data store (e.g., remote server) and builds a model state for a machine learning model. As a further example, initialization subsystem 114 may be configured to initialize the workflow by extracting a large set of data, e.g., from a data store. The batch processing task can be used to process this data in an automated manner by performing filtering, cleaning, and/or transformation. Once the data is processed, the system may then use the data to build an initial model state (e.g., a current configuration of the machine learning model, including the values of its parameters and weights) for a machine learning model within the workflow, which can be stored for further use when refreshing or otherwise updating the model.

In one scenario, with respect to step 404, the initialization subsystem 114 may access a data store containing historical patient records for a healthcare application. The batch processing task may begin by extracting a large dataset that includes patient demographics, treatment histories, clinical outcomes, etc. This data may be subject to a series of preprocessing steps, including the removal of duplicate records, normalization of numerical values such as lab test results, and encoding of categorical variables like medication types. Once the data is cleaned and transformed into a suitable format, the initialization subsystem 114 may employ a machine learning algorithm, such as a random forest classifier, to build an initial model state. This model state includes the set of decision trees and their corresponding feature thresholds that have been determined to be predictive of patient readmission (e.g., within 30-days post-discharge or other time period).

In a further scenario, the resulting model state is then stored, for example, in a model registry within the remote server 140. This registry allows for versioning of model states, enabling the system to retrieve and utilize previous versions if the newly trained model does not meet performance expectations. The stored model state serves as the foundation for the machine learning workflow and can be accessed by compute instances for real-time patient readmission risk assessment. As the workflow operates, the system continuously monitors the dynamic runtime workflow parameter (e.g., periodic monitoring or automatically in response to one or more triggers), which may be set to trigger a retraining process if the model's accuracy falls below a predefined threshold or if a new batch of patient data becomes available. This ensures that the machine learning model remains up-to-date and accurate, reflecting the latest trends and patterns in the healthcare data or other dataset of interest.

At step 406, process 400 (e.g., using one or more components described above) includes generating a dynamic runtime workflow parameter based on the criteria. For example, the dynamic runtime workflow parameter may include a value configured to dynamically modify based on specific conditions of the workflow. In one example, as discussed, the criteria may include a time-limit (e.g., a maximum amount of time that can elapsed since a recorded start time of each compute instance of the workflow before termination of the at least one compute instance). The dynamic runtime workflow parameter may be representative of the time remaining, calculated based on the current time, the time when an instance is deployed, and the maximum time specified by the criteria.

At step 408, process 400 (e.g., using one or more components described above) includes deploying the workflow by generating a compute instance, where each compute instance may be generated with the dynamic runtime workflow parameter. For example, deploying the workflow may include generating a pre-determined number of compute instances, wherein each compute instance is configured with the dynamic runtime workflow parameter and a start time is recorded for each compute instance.

At step 410, process 400 (e.g., using one or more components described above) includes modifying, for at least one compute instance, a value of a corresponding dynamic runtime workflow parameter based on the specific conditions of the workflow. For example, it may include modifying, for at least one compute instance, a value of a corresponding dynamic runtime workflow parameter based on the specific conditions of the workflow.

At step 412, process 400 (e.g., using one or more components described above) includes determining that the at least one compute instance has met or exceeded a time value indicated by the dynamic runtime workflow parameter. For example, step 414 may include determining, based on the dynamic runtime workflow parameter and the start time of the at least one compute instance, that the at least one compute instance has met or exceeded a time value indicated by the dynamic runtime workflow parameter.

In one use case, with respect to steps 404-412, the dynamic runtime workflow parameter may be instantiated as a countdown timer for each compute instance. This timer starts counting down from the maximum time limit specified in the criteria upon the deployment of the compute instance. The specific conditions of the workflow that may affect the dynamic runtime workflow parameter include the volume of data processed, the complexity of tasks performed, and the performance metrics of the machine learning model. For instance, if the criteria specify a maximum time limit of 3600 seconds since the start time of each compute instance, the dynamic runtime workflow parameter is set to 3600 seconds at the time of deployment. As the compute instance processes data and performs tasks, the system continuously monitors the countdown timer. In a further use case, if the workflow processes a larger volume of data than anticipated, causing a potential delay in completing tasks within the specified time limit, the system may dynamically adjust the countdown timer to extend the time limit, ensuring that the machine learning model has sufficient time to process the data and maintain accuracy.

On the other hand, in another use case, if the compute instance completes its tasks more quickly than expected, the system may reduce the countdown timer, allowing for an earlier termination and update of the compute instance, thereby optimizing resource usage and ensuring that the machine learning model is updated more frequently to reflect the latest data trends. In this way, for example, the dynamic nature of the runtime workflow parameter allows for real-time adjustments based on the actual performance and operational conditions of the workflow, providing a flexible and efficient mechanism for maintaining the relevance and accuracy of the machine learning model within the workflow.

According to some embodiments, responsive to determining that the at least one compute instance has met or exceeded the time value, the system may terminate the at least one compute instance of the workflow. As described herein, the workflow may be preset with a desired replica count such that when one compute instance fails, the replacement compute instance is generated and deployed to maintain the desired replica count. Because of this, responsive to detecting that a compute instance is terminated, the system may automatically generate a replacement compute instance and further deploy the replacement compute instance. In some examples, the desired replica count may be defaulted to a value, such as one or three, while in other examples, the user may indicate, e.g., as part of the request, a desired replica count.

The new compute instance may begin execution from the top of the workflow, which may include model retraining from a batch source. The compute instance may then resume inference or classification on data, e.g., from a streaming source, using the newly retrained model. In some examples, the model may be retrained, e.g., by resetting parameters of the model state. Alternatively or additionally, the model may be refreshed by updating parameters of the model state using historical data (e.g., recent streaming data).

According to some examples, the system may be further configured to receive values indicative of performance of the machine learning model. For example, the machine learning model may be used to identify anomalous events and may use the responses of users to the identified event to determine whether the events are anomalous and indicative of fraud or not. The system may use such data to determine whether the model is accurate, e.g., predicting anomalous, potentially fraudulent events at a high rate. Responsive to determining that the values do not meet a minimum threshold performance, the system may cause the machine learning model to be refreshed by updating parameters of the model state using historical data and/or retraining the machine learning model by resetting parameters of the model state, e.g., as described herein with reference to FIG. 2A and FIG. 2B.

In one scenario, with respect to step 402-412, the system may deploy a workflow designed for real-time transaction fraud detection. The system may initialize the workflow by executing a batch processing task that processes historical transaction data stored in a secure data store to build an initial model state for a machine learning model. After the model is trained (e.g., to recognize patterns indicative of fraudulent activity based on features such as transaction amount, location, merchant type, etc.), the system may generate a dynamic runtime workflow parameter (e.g., based on one or more criteria specified in a request). As an example, the criteria for the workflow parameter may require that each compute instance of the workflow is to be terminated after processing 1,000,000 transactions or after 24 hours of continuous operation, whichever comes first. This parameter is designed to ensure that the model is regularly updated with the latest transaction data to maintain high accuracy in fraud detection.

In a further scenario, to deploy the workflow, the system may generate a predetermined number of compute instances, each configured with the dynamic runtime workflow parameter. In this example, the financial institution may request three compute instances to be run in parallel to handle high transaction volumes efficiently. Each compute instance is assigned a start time upon deployment, which is recorded for monitoring purposes. As the compute instances operate, the system continuously monitors their performance and the dynamic runtime workflow parameter. If a compute instance processes the specified number of transactions or reaches the 24-hour time limit, the system modifies the value of the dynamic runtime workflow parameter to indicate that the instance has met the termination criteria. Upon determining that a compute instance has met or exceeded the time value indicated by the dynamic runtime workflow parameter, the system terminates the instance. This termination triggers the automatic generation and deployment of a replacement compute instance, ensuring that the fraud detection workflow remains operational without interruption. The new instance is initialized with an updated model state, which may include retraining the machine learning model with the latest batch of transaction data or refreshing the model parameters using recent historical data to reflect current fraud trends.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: receiving a request for deploying a workflow from a user at a user device, wherein the request comprises (i) the workflow and (ii) one or more criteria for modification of a timeout interval for the workflow; initializing the workflow by executing a batch processing task that consumes data from a data store and builds a model state for a machine learning model; generating a dynamic runtime workflow parameter based on the one or more criteria, wherein the dynamic runtime workflow parameter has a value configured to dynamically modify based on specific conditions of the workflow; deploying the workflow by generating a pre-determined number of compute instances, wherein each compute instance is configured with the dynamic runtime workflow parameter and a start time is recorded for each compute instance; modifying, for at least one compute instance, a value of a corresponding dynamic runtime workflow parameter based on the specific conditions of the workflow; and determining, based on the dynamic runtime workflow parameter and the start time of the at least one compute instance, that the at least one compute instance has met or exceeded a time value indicated by the dynamic runtime workflow parameter.
2. The method of the preceding embodiment, further comprising: responsive to determining that the at least one compute instance has met or exceeded the time value, terminating the at least one compute instance of the workflow.
3. The method of any of the preceding embodiments, further comprising: identifying an anomalous event based on an output of the machine learning model of the workflow; and transmitting, to a remote device, a notification indicative of occurrence of the anomalous event.
4. The method of any of the preceding embodiments, further comprising: responsive to detecting that a compute instance is terminated, automatically generating a replacement compute instance; and deploying the replacement compute instance.
5. The method of any of the preceding embodiments, wherein initializing the replacement compute instance comprises retraining the machine learning model by resetting parameters of the model state.
6. The method of any of the preceding embodiments, wherein initializing the replacement compute instance comprises refreshing the machine learning model by updating parameters of the model state using historical data.
7. The method of any of the preceding embodiments, wherein the workflow is preset with a desired replica count such that when one compute instance fails, the replacement compute instance is generated and deployed to maintain the desired replica count.
8. The method of any of the preceding embodiments, further comprising: receiving values indicative of performance of the machine learning model; and responsive to determining that the values do not meet a minimum threshold performance, causing the machine learning model to be refreshed by updating parameters of the model state using historical data.
9. The method of any of the preceding embodiments, further comprising: receiving values indicative of performance of the machine learning model; and responsive to determining that the values do not meet a minimum threshold performance, causing the machine learning model to be retraining the machine learning model by resetting parameters of the model state.
10. The method of any of the preceding embodiments, wherein the one or more criteria comprises a maximum amount of time elapsed since a recorded start time of each compute instance of the workflow before termination of the at least one compute instance.
11. The method of any of the preceding embodiments further comprising receiving, from a remote device, a user input for the pre-determined number of compute instances.
12. A tangible, non-transitory, machine-readable medium (e.g., computer-readable medium) storing instructions that, when executed by a data processing apparatus, cause the data processing apparatus to perform operations comprising those of any of embodiments 1-11.
13. A system comprising: one or more processors; and memory storing instructions that, when executed by the one or more processors, cause the processors to effectuate operations comprising those of any of embodiments 1-11.
14. A system comprising means for performing any of embodiments 1-11.
15. A system comprising cloud-based circuitry for performing any of embodiments 1-11.

What is claimed is:

1. A system for continuous update of a machine learning workflow, the system comprising:
one or more processors; and
a non-transitory, computer-readable medium comprising instructions that, when executed by the one or more processors, causes operations comprising:
receiving a request for deploying a workflow from a user at a user device, wherein the request comprises (i) the workflow and (ii) one or more criteria for modification of a timeout interval for the workflow;
initializing the workflow by executing a batch processing task that consumes data from a data store and builds a model state for a machine learning model configured to identify anomalous events;
generating a dynamic runtime workflow parameter based on the one or more criteria, wherein the dynamic runtime workflow parameter has a value configured to dynamically modify based on specific conditions of the workflow;
deploying the workflow by generating a pre-determined number of compute instances, wherein each compute instance is configured with the dynamic runtime workflow parameter and a start time is recorded for each compute instance;
modifying, for at least one compute instance, a value of a corresponding dynamic runtime workflow parameter based on the specific conditions of the workflow;
determining, based on the dynamic runtime workflow parameter and the start time of the at least one compute instance, that the at least one compute instance has met or exceeded a time value indicated by the dynamic runtime workflow parameter; and
responsive to determining that the at least one compute instance has met or exceeded the time value, terminating the at least one compute instance of the workflow.

2. A method comprising:
receiving a request for deploying a workflow from a user at a user device, wherein the request comprises (i) the workflow and (ii) one or more criteria for modification of a timeout interval for the workflow;
initializing the workflow by executing a batch processing task that consumes data from a data store and builds a model state for a machine learning model;
generating a dynamic runtime workflow parameter based on the one or more criteria, wherein the dynamic runtime workflow parameter has a value configured to dynamically modify based on specific conditions of the workflow;
deploying the workflow by generating a pre-determined number of compute instances, wherein each compute instance is configured with the dynamic runtime workflow parameter and a start time is recorded for each compute instance;
modifying, for at least one compute instance, a value of a corresponding dynamic runtime workflow parameter based on the specific conditions of the workflow; and
determining, based on the dynamic runtime workflow parameter and the start time of the at least one compute instance, that the at least one compute instance has met or exceeded a time value indicated by the dynamic runtime workflow parameter.

3. The method of claim 2, further comprising:
responsive to determining that the at least one compute instance has met or exceeded the time value, terminating the at least one compute instance of the workflow.

4. The method of claim 2, further comprising:
identifying an anomalous event based on an output of the machine learning model of the workflow; and
transmitting, to a remote device, a notification indicative of occurrence of the anomalous event.

5. The method of claim 2, further comprising:
responsive to detecting that a compute instance is terminated, automatically generating a replacement compute instance; and
deploying the replacement compute instance.

6. The method of claim 5, wherein initializing the replacement compute instance comprises retraining the machine learning model by resetting parameters of the model state.

7. The method of claim 5, wherein initializing the replacement compute instance comprises refreshing the machine learning model by updating parameters of the model state using historical data.

8. The method of claim 5, wherein the workflow is preset with a desired replica count such that when one compute instance fails, the replacement compute instance is generated and deployed to maintain the desired replica count.

9. The method of claim 2, further comprising:
receiving values indicative of performance of the machine learning model; and
responsive to determining that the values do not meet a minimum threshold performance, causing the machine learning model to be refreshed by updating parameters of the model state using historical data.

10. The method of claim 2, further comprising:
receiving values indicative of performance of the machine learning model; and
responsive to determining that the values do not meet a minimum threshold performance, causing the machine learning model to be retraining the machine learning model by resetting parameters of the model state.

11. The method of claim 2, wherein the one or more criteria comprises a maximum amount of time elapsed since a recorded start time of each compute instance of the workflow before termination of the at least one compute instance.

12. The method of claim 2, further comprising receiving, from a remote device, a user input for the pre-determined number of compute instances.

13. One or more non-transitory, computer-readable media comprising instructions recorded thereon that, when executed by one or more processors, cause operations comprising:
receiving a request for deploying a workflow from a user at a user device, wherein the request comprises (i) the workflow and (ii) one or more criteria for modification of a timeout interval for the workflow;
initializing the workflow by executing a batch processing task that consumes data from a data store and builds a model state for a machine learning model;
generating a dynamic runtime workflow parameter based on the one or more criteria, wherein the dynamic runtime workflow parameter has a value configured to dynamically modify based on specific conditions of the workflow;
deploying the workflow by generating a pre-determined number of compute instances, wherein each compute instance is configured with the dynamic runtime workflow parameter and a start time is recorded for each compute instance;
modifying, for at least one compute instance, a value of a corresponding dynamic runtime workflow parameter based on the specific conditions of the workflow; and
determining, based on the dynamic runtime workflow parameter and the start time of the at least one compute instance, that the at least one compute instance has met or exceeded a time value indicated by the dynamic runtime workflow parameter.

14. The one or more non-transitory, computer-readable media of claim 13, wherein the instructions further cause operations comprising: responsive to determining that the at least one compute instance has met or exceeded the time value, terminating the at least one compute instance of the workflow.

15. The one or more non-transitory, computer-readable media of claim 13, wherein the instructions further cause operations comprising:
identifying an anomalous event based on an output of the machine learning model of the workflow; and
transmitting, to a remote device, a notification indicative of occurrence of the anomalous event.

16. The one or more non-transitory, computer-readable media of claim 13, wherein the instructions further cause operations comprising:
responsive to detecting that a compute instance is terminated, automatically generating a replacement compute instance; and
deploying the replacement compute instance.

17. The one or more non-transitory, computer-readable media of claim 16, wherein initializing the replacement compute instance comprises retraining the machine learning model by resetting parameters of the model state.

18. The one or more non-transitory, computer-readable media of claim 16, wherein initializing the replacement compute instance comprises refreshing the machine learning model by updating parameters of the model state using historical data.

19. The one or more non-transitory, computer-readable media of claim 13, wherein the instructions further cause operations comprising:
receiving values indicative of performance of the machine learning model; and
responsive to determining that the values do not meet a minimum threshold performance, causing the machine learning model to be refreshed by updating parameters of the model state using historical data.

20. The one or more non-transitory, computer-readable media of claim 13, wherein the instructions further cause operations comprising:
receiving values indicative of performance of the machine learning model; and
responsive to determining that the values do not meet a minimum threshold performance, causing the machine learning model to be retraining the machine learning model by resetting parameters of the model state.
